(19) United States
(12) Patent Application Publication
(10) Pub. No.: US 2009/0112640 A1
(43) Pub. Date: Apr. 30, 2009

(54) Method for providing overnight accommodations

(76) Inventors: Daxesh Patel, Somerset, NJ (US); Ashish Patel, Somerset, NJ (US)

Correspondence Address: HEDMAN & COSTIGAN P.C., 1185 AVENUE OF THE AMERICAS, NEW YORK, NY, 10036, US

(21) Appl. No.: 11/978,833

(22) Filed: Oct. 30, 2007

(51) Int. Cl. G06Q 10/00; G06Q 30/00

(52) U.S. Cl. 705/5; 705/14

(57) ABSTRACT

A method of renting out one or more rooms by a Provider is disclosed. The Provider acquires a block of one or more rooms from an overnight accommodations operator for a long term basis. The Provider then sets a price for a room in a geographic area at a consistent price. The Provider then rents the room to a Customer, wherein the proceeds from the room rental are payable to the Provider.

### FIELD OF THE INVENTION

The present invention relates to methods of renting out overnight accommodations (“ONA”) to travelers. More particularly, the present invention relates to methods of obtaining long-term rentals of ONAs and renting those ONAs to travelers for short term stays at substantially flat rates.

### BACKGROUND OF THE INVENTION

The world has become a much smaller place due to innovations in travel. Therefore, people are spending much more time away from their homes and offices, often with overnight stays in different states or even different countries. These travelers almost always stay at various ONA facilities, however, these ONA facilities do not come cheaply. Therefore, travelers seeking an ONA for only short stays, such as an overnight layover between flights, are looking for cost efficient options.

ONA operators are also aware that demand for ONAs can vary with the season, and the operators price the ONAs to meet the demand. That is, in seasons when ONAs are more sought after, operators charge a premium; during seasons when ONAs are not in high demand, operators may lower prices in order to entice travelers. However, some people wish to bargain for lower prices on ONAs, and ONA operators also wish to dispose of unused inventory at a profit.

Internet websites like EXPEDIA®, PRICELINE®, ORBITZ® and others seek to accommodate these bargain-hunters by acting as an intermediary between travelers and underbooked ONA facilities. ONA facilities generally have average occupancy rates of only about 65% to 75%, therefore, they often have a surplus of capacity. It is this surplus that Internet websites attempt to tap. The ONA operator benefits because it is able to rent out a room it may otherwise have had vacant; the website benefits because it keeps a percentage of the transaction cost or a flat assessed fee as its profit; and the traveler benefits because the traveler obtains a room at a discounted price.

There are drawbacks to this standard method, however. For example, up until the room is booked, the ONA operator is not assured of selling the room. Additionally, room rates are artificially increased over what they need to be because the Internet website adds in its own profit margin.

Various patents have been issued, and several applications are pending, that seek to match vacant rooms with travelers at discounted prices. For example, U.S. Patent Publication No. 2007/0075136 is directed to a hotel inventory management system that is based on a best available rate pricing system, where all rates are derived from the best available rate (“BAR”) rather than pricing the different types of rooms differently. This reduces the work on the property administrator, who does not need to reset the pricing for all types of rooms; the administrator only needs to provide the BAR, and an algorithm sets the rest of the rates. While this publication describes a portal for offering reservations on a group of properties managed as an entity, it does not offer the best pricing to the traveler since it acts only as a portal. Further, it does not describe a one-price scheme for all rooms in a geographic area, instead using one price as merely a basis for pricing all other rooms.

U.S. Patent Publication No. 2004/0267567 is directed to a hospitality management system for a hospitality organization having geographically distributed business entities. It can be applied to a hotel room rental organization where a centralized inventory of rooms is maintained for rental, which can provide uniform pricing over a variety of distribution channels through the use of centralized data. However, the system used includes the steps of receiving a request for a pricing proposal associated with at least one of the facilities associated with one of the business entities. In response to the request, a quote based on the data in the centralized inventory system is generated and sent to the requesting party. The publication does not describe a one-price scheme for all rooms in a geographic area from the various entities or the best pricing to travelers.

U.S. Patent Publication No. 2007/0038503 is directed to an event management program where an inventory of event hospitality items, including hotel rooms, is acquired. The inventory is then used to provide a hospitality program for groups or individuals. However, this publication does not suggest that the inventory items are acquired by the entity providing the hospitality program. Rather, the entity merely compiles a listing of the resources available in a particular area. The publication also fails to suggest a one-price scheme for rooms in a given area, instead limiting the service in accordance with the underlying event.

Similarly, U.S. Patent Publication No. 2002/0069094 is directed to a system for reserving meeting facility resources where multiple meeting resource facilities are available. The publication contemplates taking the desired information and reserving the particular resources of the facilities desired by the user, including a block of hotel rooms for the meeting participants. This system, however, does not suggest providing the best prices to travelers or a one-price scheme for customers seeking a facility in a geographic area. Rather, the system merely automates reserving a plurality of facilities for a meeting.

Finally, U.S. Patent Publication No. 2005/0154620 is directed to a system that arranges for group reservations for a number of guests through the use of an Internet search based on the requirements of the group. Once the search is complete, the system notifies the hotel group managers to respond with particulars so that the group may make its decision. However, this publication does not suggest that the service obtains rental units to be distributed to groups of individuals or a one-price scheme in a geographic area, instead allowing the hotel facility to determine its own pricing at the time of the inquiry by the Customer.

### SUMMARY OF THE INVENTION

Therefore, it is an object of the present invention to provide a new and improved system for booking discounted ONAs by travelers.

A further object of the present invention is to allow an ONA operator to rent out a block of rooms for a long term, thus ensuring an increased percentage of occupancy.

An even further object of the present invention is to allow a traveler to obtain quality ONAs wherein the price is independent of the season in which the traveler is traveling.

Yet a further object of the present invention is to allow a traveler to obtain quality ONAs wherein the price is independent of the date or season or the length of time between when the reservation is made and when the traveler stays at the ONA.

Still another object of the present invention is to allow a traveler to obtain quality ONAs wherein the price is independent of the supply-and-demand for ONAs in a geographic area.

Yet another object of the present invention is to allow an ONA operator to dispose of unused inventories of ONAs at a profit.

These and other objectives not specifically mentioned are fulfilled by the invention of the present application, wherein provided is a method of renting out one or more rooms by a Provider comprising the steps of the Provider acquiring a block of one or more rooms from an ONA operator on a long term basis, setting a consistent price for a room type within a geographic area, and renting out one or more rooms to a Customer who remits payment for the room directly to the Provider. The ONA operator can be an operator of a hotel, motel, bed-and-breakfast, lodge, inn and/or other over-night accommodations.

Preferably, the Provider attracts Customers by various forms of advertising and, when the Provider rents out a room to a Customer, the Provider collects various information from the Customer and assigns a reservation to the Customer. Also preferably, the Provider provides a room key to the Customer in some form, however, it is also acceptable if the ONA operator provides a room key to the Customer.

It is further preferred that the Customer pays the Provider when booking the ONA, however, it is acceptable for the Customer to pay the Provider at any time subsequent to booking the ONA. It is understood that when payment to the Provider is mentioned, it includes payment to the Provider's designated representative, such as a bank, billing agency, or through the ONA operator itself to arrange for payment from the Customer to the Provider. Further, after the overnight accommodations are used, a Customer preferably checks out by contacting the ONA operator but the Customer may alternatively check out by contacting the Provider or its designated representative. Regardless of the method used to check out, it is preferred that the Provider and the ONA operator communicate with each other regarding the Customer's check out.

Optionally, a Provider may grant incentives to a frequent Customer. Incentives may include discounts, gifts such as gift baskets or champagne, room service certificates, etc., either deliverable to the Customer by the Provider or the ONA operator.

### BRIEF DESCRIPTION OF THE DRAWINGS

The attached drawing is intended to better illustrate the present invention, without limiting it in any manner whatsoever.

FIG. 1 is a flow sheet diagram depicting the preferred steps of the present invention.

### DETAILED DESCRIPTION OF THE PREFERRED EMBODIMENT

The following description is presented to describe the preferred embodiments of the present invention, without limiting the scope of the appended claims.

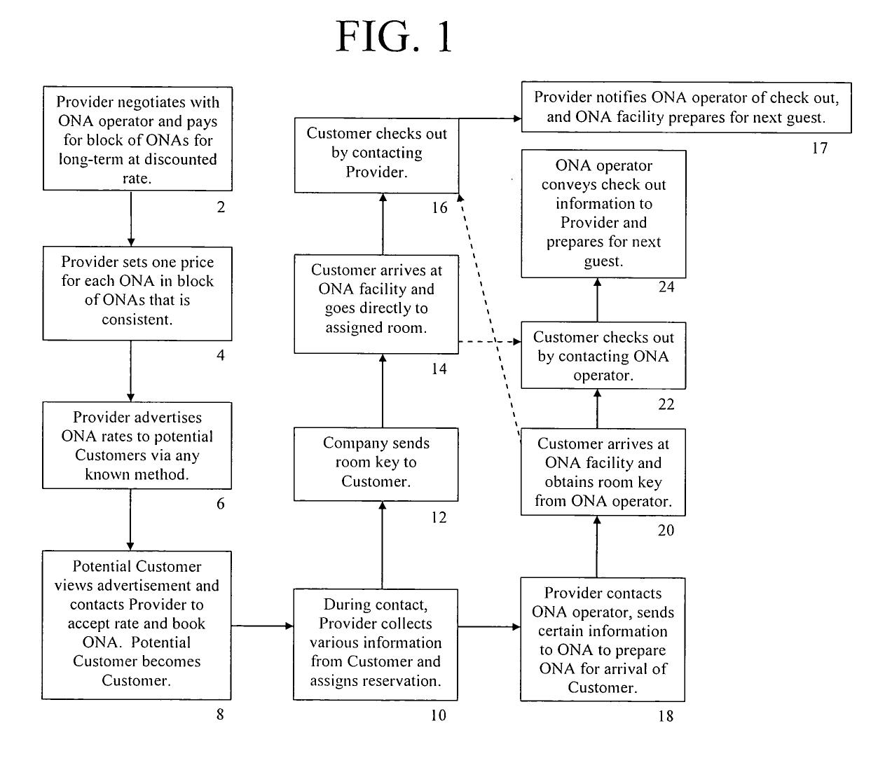

The present invention provides a method of renting ONAs to travelers at fixed standard rates, wherein the price is independent of the season. As best shown in FIG. 1, a Provider seeks out ONA facilities it deems desirable and negotiates with the ONA operator to book a block of rooms for a long term of time and at a discounted rate (2). The ONA facility can be deemed desirable based on many factors including, but not limited to, quality, number of stars received, proximity to a transportation centers (e.g., train stations, airports and bus stations), name recognition, proximity to downtown areas, etc. The number of rooms in the block of rooms can be anywhere from one room up to the maximum number of rooms in the ONA facility in question, but most preferred is from two rooms to about ten rooms.

It is anticipated that the Provider can obtain rooms relatively cheaply because it is acquiring in bulk (in terms of number of rooms and/or length of term) and can therefore ensure occupancy of the block of rooms over the long term period, and therefore a greater occupancy rate, for the ONA operator. The block of rooms can be acquired by any know agreement, including rental, lease, etc.

The long-term basis that the Provider books the block for can range from several months to several years or more, however, most preferred is about one year or more. Therefore, when discussing the invention, the assumed period of time for the long term acquisition of the block of rooms will be one year, although it is to be understood that any long-term period of time, ranging from several weeks to several years or more, is encompassed by the present invention.

Once the Provider has negotiated with the ONA operator and obtained a block of rooms for a long-term (2), the Provider sets a standard rate per room at which the Provider will rent the room out to individual Customers (4). It is most preferred that a specific room in a specific geographic area will have a fixed standard rate throughout the year. However, one room in a geographic area may have a different price than another room in the geographic area due to, for example, the size of the room or the amenities associated with a room, etc.

Once the Provider has set a standard rate (4), the Provider may advertise (6) its rates and availabilities to the consuming public, i.e., potential Customers. The advertising can be of any form known to those in the art including, but not limited to, email offers, website advertisements, newspaper advertisements, magazine advertisements, billboards, posters, television commercials, radio commercials, flyers, handouts, direct mailings, and telemarketing. The advertising may be initiated by the Provider or one or more entities at the direction of the Provider.

When an advertisement reaches a potential Customer who is interested in booking a room, the potential Customer contacts the Provider to accept the rate and book the room (8). The potential Customer is now an actual Customer. The contact between the potential Customer and Provider can take the form of any method of contact including, but not limited to, email, Internet website, telephone, mail service, courier service or the like. Most preferred is contact via email, Internet or telephone.

During the actual contact (8), the Provider may collect various information from the Customer (10), including but not limited to payment information (e.g., credit or debit card information), Customer name, Customer home address, Customer contact information, etc. The Provider assigns the Customer a room at Customer's desired hotel, informs the Customer of the reservation, check-in time, check-out time and any other information the Customer requests.

In a preferred embodiment, after the Provider collects information from a Customer (10) and assigns the reservation, the Provider contacts the ONA operator and conveys certain information regarding the reservation, including the particular Customer, to the ONA operator (18). This information, for example, may include the Customer's name, address, credit card information, etc. In this way, the ONA operator can prepare for the Customer's arrival, e.g., by having a key or keycard ready for the Customer when the Customer arrives (20). Once the Customer has completed his or her stay, the Customer can check out by contacting the ONA operator (22). The ONA operator conveys the fact that the Customer has checked out to the Provider (24), and the ONA operator can prepare for the next guest.

Depending on the agreement with the Customer, the Customer's payment will be collected by the Provider or its designated representative either prior to or after the Customer's stay has been completed, or as a pre-stay deposit and post-stay final payment. This can be done by charging the Customer's credit or debit card, or by collecting cash or a check. Preferably, the payment is taken directly by the Provider, however, the present invention is not so limited. In this regard, the Provider's designated representative such as a bank, a billing agency or even through the ONA operator itself, to arrange for receipt of payment from the Consumer and corresponding payment to the Provider.

The Customer may obtain the key to the assigned room via one of several methods other than directly from the ONA facility. In one embodiment of the present invention, the Provider sends the room keycard pre-coded with the Customer's room information (e.g., room number, dates of stay) to the Customer (12). It is also envisioned that either an identification card (e.g., a driver's license encoded with the Customer's name) or a credit/debit card (either the card the Customer uses to book the room or a different card with the Customer's name encoded on it) can be used as the room key, in which case the Provider “sends” the key to the Customer by informing the Customer to use the ID or credit/debit card as the key.

In this embodiment, once the Customer receives the key (or is informed to use an ID or credit/debit card), the Customer need merely arrive at the assigned ONA facility and proceed directly to the assigned room (14). Once the Customer has stayed the assigned (and paid-for) number of days/nights, the Customer can check out by contacting the Provider (16). The Provider may optionally notify the ONA operator that the Customer is checking out so that the ONA operator can prepare the room for the next guest (17). It is also envisioned that the Provider does not notify the ONA operator when the Customer checks out and that the ONA operator prepares the room as if for a new Customer every night. However, it is possible that an arrangement wherein the Provider agrees to notify the ONA operator of the checkout may result in savings to the ONA operator which may be passed on to the Provider and/or Customer.

It is preferred that the Customer checks out by contacting the ONA operator (22), i.e., by visiting the front desk, accessing a remote system set up by the ONA operator, etc. The ONA operator preferably conveys the fact that the Customer has checked out to the Provider (24), and the ONA operator can prepare for the next guest.

It is also envisioned that the Customer can check out by contacting the Provider (16). However, the Customer may need to return the key to the ONA operator (not shown in FIG. 1). If the Customer checks out by notifying the Provider (16), the Provider may optionally notify the ONA operator that the Customer is checking out so that the hotel can prepare the room for the next guest (17). It is also envisioned that the Provider does not notify the ONA operator when the Customer checks out and that the ONA operator prepares the room as if for a new Customer every night. However, it is possible that an arrangement wherein the Provider notifies the ONA operator of the checkout may result in savings to the ONA operator which may be passed on to the Provider and/or Customer.

A Provider may also institute a loyalty program wherein frequent Customers receive incentives at one or more rooms in the Provider's stable of rooms. These incentives may include, but are not limited to, discounts, gifts such as gift baskets or champagne, room service certificates or the like.

Many variations of the present invention will suggest themselves to those skilled in the art in light of the above-detailed description. For example, the type of key that can be used may include conventional keys, keycards, alpha-numeric codes, passwords, and the like. Additionally, the invention could be modified to cover rental cars, airline travel, and the like, so long as it is a commodity that can be acquired for a long term basis and distributed to Consumers for shorter term availability. All such variations, modifications and changes are intended to fall within the spirit and scope of the present invention, limited solely by the appended claims.

The above-referenced patents and patent applications are hereby incorporated by reference.

1. A method of renting out one or more rooms by a Provider comprising the steps of:
a) the Provider acquiring a block of one or more rooms from an ONA operator for a long term basis;
b) setting a consistent price for a room type in a geographic area; and
c) renting out one or more of said rooms to a Customer wherein the proceeds for the room rental are payable to the Provider.

2. The method of claim 1 wherein the step of renting out said room to said Customer comprises one or more of the following steps:
a) advertising said room to potential Customers;
b) receiving a contact from a potential Customer;
c) agreeing to terms with said potential Customer;
d) renting said room to said potential Customer, thereby creating a Customer;
e) collecting information from said Customer; and
f) providing a key to said Customer.

3. The method of claim 1 further comprising the step of supplying a room key to said Customer.

4. The method of claim 3 wherein said Customer obtains said room key from said ONA operator or said Provider.

5. The method of claim 1 wherein said Customer checks out of said room by contacting said Provider.

6. The method of claim 5 wherein said Provider relays check out information to said ONA operator.

7. The method of claim 1 wherein said Customer checks out of said room by contacting said ONA operator.

8. The method of claim 7 wherein said ONA operator relays said check out information to said Provider.

9. The method of claim 1 wherein a frequent Customer receives a discounted rate or an incentive on said room.

10. The method of claim 2 wherein said rooms acquired by the Provider on a long term basis are advertised via at least one medium selected from the group consisting of email offers, website advertisements, newspaper advertisements, magazine advertisements, television commercials, radio commercials, flyers, handouts, direct mailings, and telemarketing offers.

11. The method of claim 2 wherein said contact between said potential Customer and said Provider comprises at least one mode selected from the group consisting of email, Internet website, telephone contact, mail service and carrier service.

12. The method of claim 1 wherein said ONA operator comprises one or more entities selected from the group consisting of hotel operators, motel operators, bed-and-breakfast operators, lodge operators, and inn operators and wherein said room is located at one or more selected from the group consisting of hotels, motels, bed-and-breakfasts, lodges and inns.

13. The method of claim 2 wherein said information collected from said Customer comprises one or more selected from the group consisting of payment information, Customer name, Customer home address and Customer contact information.

14. The method of claim 13 wherein said payment information comprises credit card information.

15. The method of claim 1 wherein said long term basis comprises from about one week to about several years.

16. The method of claim 15 wherein said long term basis comprises about one year.

17. The method of claim 3 wherein said room key comprises one selected from the group consisting of a conventional key, a keycard, a credit card, a debit card, an identification card, an alpha-numeric code, and a password.

18. A method of renting out one or more items or services by a Provider comprising the steps of:
a) the Provider acquiring a block of one or more items and/or services from an item and/or service operator for a long term basis;
b) setting a price for each item and/or services in said block wherein said price is consistent in a geographic area; and
c) renting out said item and/or service to a Customer wherein the proceeds for the item and/or service rental are payable to the Provider.

19. The method of claim 18 wherein said one or more items and/or services comprises one or more selected from the group consisting of ONA rooms, rental cars and airline travel.
